(19) United States
(12) Patent Application Publication
(10) Pub. No.: US 2013/0074551 A1
(43) Pub. Date: Mar. 28, 2013

(54) METHOD OF MAKING MULTI-CORE OPTICAL FIBER AND METHOD OF MAKING MULTI-CORE OPTICAL FIBER CONNECTOR

(71) Applicant: Eisuke SASAOKA, Yokohama-shi (JP)

(72) Inventor: Eisuke SASAOKA, Yokohama-shi (JP)

(73) Assignee: SUMITOMO ELECTRIC INDUSTRIES, LTD., Osaka-shi (JP)

(21) Appl. No.: 13/627,084

(22) Filed: Sep. 26, 2012

Related U.S. Application Data
(60) Provisional application No. 61/611,183, filed on Mar. 15, 2012.

(30) Foreign Application Priority Data
Sep. 27, 2011 (JP) 2011-211308

(51) Int. Cl. G02B 6/24; C03B 37/023

(52) U.S. Cl. 65/386; 65/409

(57) ABSTRACT

The present invention, even in the case where the size of a preform itself is increased, enables production of a multi-core optical fiber in which cores are arranged with high accuracy. A plurality of core members each being rod-like are fixed by an array fixing member while a relative positional relation of the plurality of core members is fixed, and the plurality of core members and a cladding member are integrated into one piece, and thus a preform is obtained. By drawing the obtained preform, a multi-core optical fiber in which core arrangement is controlled with high accuracy is obtained.

### BACKGROUND OF THE INVENTION

1. Field of the Invention

The present invention relates to a production method of a multi-core optical fiber and a production method of a multi-core optical fiber connector.

2. Related Background of the Invention

As a method of production a multi-core optical fiber which is an optical fiber with a plurality of cores covered with a cladding, methods described in Japanese Patent Application Laid-Open No. 09-90143 (Patent Documents 1) and International Publication No. WO99/05550 (Patent Document 2) are known, for example. In Patent Document 1, disclosed is a rod-in method of producing a multi-core optical fiber preform by providing holes for inserting a plurality of core members along the direction in which a rod serving as a cladding member extends, by inserting the associated core member into each of the provided holes, and by integrating the obtained structure into one piece. In addition, in Patent Document 2, disclosed is a stacking method of production a multi-core optical fiber preform by inserting a rod constituted by a plurality of core members and a cladding member into one hole, and by integrating the obtained structure into one piece.

### SUMMARY OF THE INVENTION

The present inventors have examined conventional production methods of a multi-core optical fiber, and as a result, have discovered the following problems.

The inventors have discovered problems described in the following, as a result of having investigated production methods of a conventional multi-core optical fiber.

In the case of trying to produce a preform having increased size and especially length by using a rod-in method as described in the Patent Document 1, the following problems arise. That is, in order to insert a plurality of core members into a cladding member, a plurality of holes is needed to be formed in a preform having increased length. However, it is very difficult to provide a plurality of holes without deteriorating position accuracy. In addition, it is also difficult to insert core members into formed holes. Therefore, it is difficult to manufacture a multi-core optical fiber having a high core position accuracy based on the rod-in method as described in the Patent Document 1.

In contrast, in the case of using the stacking method as described in the Patent Document 2, because of carrying out heating and integrating into one piece in a state where a rod constituted by the plurality of core members and the cladding member has been inserted in one hole, a core position is highly likely to be dislocated in a stage of the integration into one piece. Therefore, in the multi-core optical fiber preform after the integration into one piece, the core position is likely to shift from a target position. Since the core position shift is inevitably generated also in the multi-core optical fiber obtained by drawing the preform in which the core position shift has occurred in this way, the core position shift is likely to be generated also in a multi-core optical fiber connector produced by using this multi-core optical fiber.

The present invention has been developed to eliminate the problems described above. It is an object of the present invention to provide a production method of a multi-core optical fiber and a production method of a multi-core optical fiber connector, in which a core arrangement has been, controlled with high accuracy even in the case of increasing the size of the preform itself.

In order to achieve the above-mentioned objects, a production method of a multi-core optical fiber according to the present invention, as a first aspect, comprises the steps of: supporting a plurality of core members by an array fixing member; producing a multi-core optical fiber preform by integrating the plurality of core members and a cladding member into one piece; and obtaining the multi-core optical fiber by drawing the obtained multi-core optical fiber preform. Here, each of the plurality of core members has a rod shape. The array fixing member supports the plurality of core members while fixing a relative positional relation of the plurality of core members. Furthermore, the multi-core optical fiber preform is obtained by integrating at least plurality of core members and the cladding member into one piece after arranging the cladding member on the periphery of the plurality of core members whose relative positional relation has been fixed by the array fixing member.

In accordance with the production method of the multi-core optical fiber according to the first aspect, these plurality of core members and the cladding member are integrated into one piece while the plurality of core members are supported by array fixing members. Therefore, a position shift of each of core members at the time of the integration is suppressed, and the relative positional relation between the core members can be kept with high accuracy. In addition, in comparison with a method of inserting the core members into opening holes provided in the cladding member like the rod-in method, even in the case where the size of the multi-core optical fiber is increased (for example, expansion of a fiber diameter), it is possible to carry out assembling of a preform structure easily.

As a second aspect applicable to the first aspect, the array fixing member may be composed of the same material as the cladding member, and may be integrated into each of the plurality of core members as a part of the cladding member. By constituting the array fixing member with a material which functions as the cladding member like this, it becomes possible to support the plurality of core members reliably in a state where the relative positional relation of the plurality of core members has been reliably fixed. In addition, when the plurality of core members is reliably supported along each longitudinal direction, a position shift of each of core members can be suppressed effectively.

In addition, as a third aspect applicable to the first aspect, the multi-core optical fiber preform is obtained also by separating the array fixing member from an integrated part, the integrated part being obtained by directly integrating the plurality of core members and the cladding member into one piece while a part of each of the plurality of core members is supported by the array fixing member. In this way, in a state where a part of each of the plurality of core members is supported (a state where the relative positional relation of each of the core members is fixed), even in the case of a configuration where the plurality of core members and the cladding member are integrated into one piece, the multi-core optical fiber can be produced in a state where the array (relative positional relation) of the plurality of core members is maintained with high accuracy.

As a fourth aspect applicable to at least any of the first to third aspects, the array fixing member preferably has a plurality of concave portions each substantially corresponding to an outer peripheral shape of each of the plurality of core members. In addition, in this case, the relative positional relation of the plurality of core members is fixed by disposing each of the plurality of core members on the associated one of the plurality of concave portions of the array fixing member.

Note that, as a fifth aspect, the array fixing member in the first to fourth aspects may include a plurality of array holding members which hold in cooperation from a perpendicular direction with respect to a longitudinal direction of each of the plurality of core members.

Specifically, as a sixth aspect applicable to the fifth aspect, each of the plurality of array holding members is composed of the same material as the cladding member, and is integrated into each of the plurality of core members as a part of the cladding member. By constituting each of the plurality of array holding members with a material functioning as the cladding member like this it becomes possible to support the plurality of core members reliably in a state where the relative positional relation of the plurality of core members has been reliably fixed. In addition, when a plurality of core members is reliably held along each longitudinal direction, a position shift of each of core members can be suppressed effectively.

Moreover, as a seventh aspect applicable to the fifth aspect, the multi-core optical fiber preform is obtained by separating the plurality of array holding members from an integrated part, the integrated part being obtained by directly integrating the plurality of core members and the cladding member into one piece while a part of each of the plurality of core members is held by the plurality of array holding members. In this way, in a state where a part of each of the plurality of core members is held, even in the case of a configuration in which the plurality of core members and the cladding member are integrated into one piece, the multi-core optical fiber can be produced in a state where the array (relative positional relation) of the plurality of core members is maintained with high accuracy.

As a eighth aspect applicable to at least one of the fifth to seventh aspects, at least one of the plurality of array holding members preferably has a plurality of concave portions each substantially corresponding to an outer peripheral shape of each of the plurality of core members. In addition, in that case, the relative positional relation of the plurality of core members is fixed by disposing each of the plurality of core members on the associated one of the plurality of concave portions provided in at least one of the plurality of array holding members are allocated.

Furthermore, as a ninth aspect applicable to at least one of the first to eighth aspects, the multi-core optical fiber preform preferably has anisotropy on a cross section thereof which is perpendicular to a longitudinal direction of each of the plurality of core members. In addition, as a tenth aspect applicable to the ninth aspect, the multi-core optical fiber preform preferably has a flat edge on the cross section thereof which is perpendicular to the longitudinal direction of each of the plurality of core members.

As an eleventh aspect applicable to at least one of the first to tenth aspects, the cladding member may be constituted by a plurality of members.

In addition, as a twelfth aspect applicable to the ninth or tenth aspect, as for a production method of a multi-core optical fiber connector, a multi-core optical fiber is prepared, and by inserting the multi-core optical fiber into a hole provided on a ferrule, a multi-core optical fiber connector is obtained. Note that the prepared multi-core optical fiber is the multi-core optical fiber produced by the production method of the multi-core optical fiber according to the above-mentioned ninth aspect, and has anisotropy on a cross section thereof which is perpendicular to a longitudinal direction of each of a plurality of core members.

### BRIEF DESCRIPTION OF THE DRAWINGS

FIG. 1 is a view showing a production method of a multi-core optical fiber according to a first embodiment;

FIG. 2 is a view showing a production method of a multi-core optical fiber according to the first embodiment;

FIG. 3 is a view showing a production method of a multi-core optical fiber according to the first embodiment;

FIG. 4 is a view showing a production method of a multi-core optical fiber connector according to a second embodiment;

FIG. 5 is a view showing a production method of a multi-core optical fiber connector according to the second embodiment;

FIGS. 6A and 6B are views showing a production method of a multi-core optical fiber according to a third embodiment;

FIG. 7 is a view showing a production method of a multi-core optical fiber according to the third embodiment;

FIG. 8 is a view showing a production method of a multi-core optical fiber according to the third embodiment;

FIG. 9 is a view showing a production method of a multi-core optical fiber according to the third embodiment;

FIG. 10 is a view showing a production method of a multi-core optical fiber according to a fourth embodiment;

FIG. 11 is a view showing a production method of a multi-core optical fiber according to the fourth embodiment;

FIG. 12 is a view showing a production method of a multi-core optical fiber according to the fourth embodiment; and

FIG. 13 is a view showing a drawing process common to the first to fourth embodiments.

### DESCRIPTION OF THE PREFERRED EMBODIMENTS

In the following, with reference to the accompanying drawings, embodiments for carrying out the present invention will be described in detail. Note that, in description of the drawings, the same symbol is given to the same component, and overlapped description is omitted. In addition, each of the accompanying drawings is shown using a common XYZ-coordinate system.

### First Embodiment

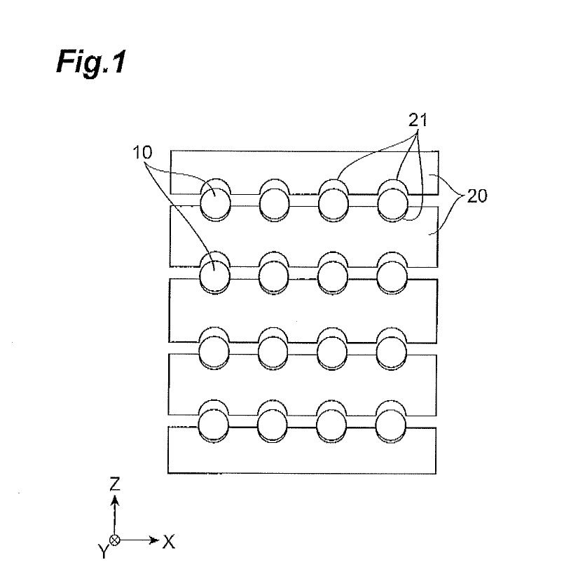

FIGS. 1 to 3 are views showing a production method of a multi-core optical fiber according to a first embodiment of the present invention. The multi-core optical fiber produced by the production method according to the present embodiment has a structure which has 16 cores in the inside, and in which a cladding is provided in an outer periphery thereof.

As shown in FIG. 1, first, there are prepared 16 core members 10 composed of pure-silica glass, and five core array holding members 20 as array fixing members for holding these core members 10 in a state where a predetermined relative positional relation has been fixed. The core array holding member 20 has concave portions 21 having substantially the same shape as a peripheral shape of 16 core members, and has the silica glass to which fluorine is uniformly added so that the difference in a relative refractive index with respect to the pure-silica glass becomes −0.35%. Then, each of core members 10 is arranged one by one in each concave portion 21 of the core array holding member 20. More specifically, as shown in FIG. 1, the core array holding member 20 has concave portions each provided in one row so that four core members 10 may be arrayed on the same plane at regular intervals. Then, by the fact that this is laminated in four layers, the 16 core members 10 are arranged in four rows and columns. Note that, among the core array holding members 20 of the upper end and lower end, concave portions 21 are not formed on a surface which does not contact the core member 10. In addition, although the core members 10 and the core array holding members 20 are indicated like being floated in FIG. 1, these are put together at the time of production. Because of this, the core members 10 are held by the core array holding members 20 from a perpendicular direction with respect to a longitudinal direction of the core members 10.

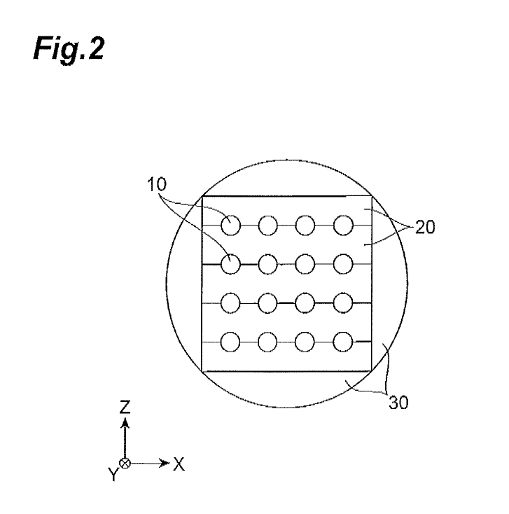

Next, as shown in FIG. 2, in a state where the core members 10 have been arranged at each concave portion 21, four peripheral holding members 30 are arranged on an outer periphery of the core array holding members 20 laminated in four layers. Because of this, a structure with a cross-section structure (a shape viewed from a plane shown by FIGS. 1 to 4) of substantially a circular shape is obtained. Note that, the peripheral holding member 30 is formed with the same material as the core array holding member 20. That is, there is used a material with the silica glass to which fluorine is uniformly added so that the difference in a relative refractive index with respect to the pure-silica glass becomes −0.35%.

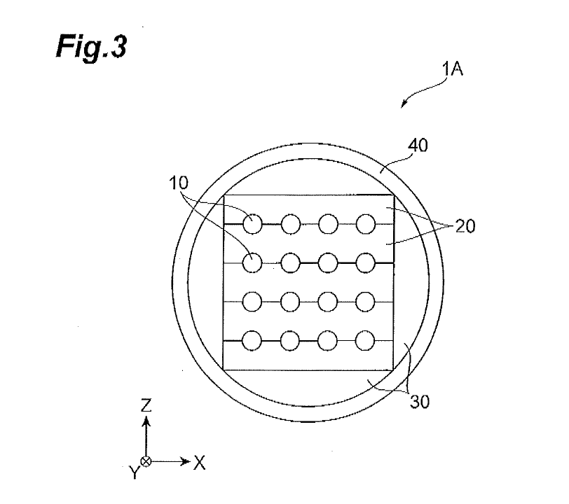

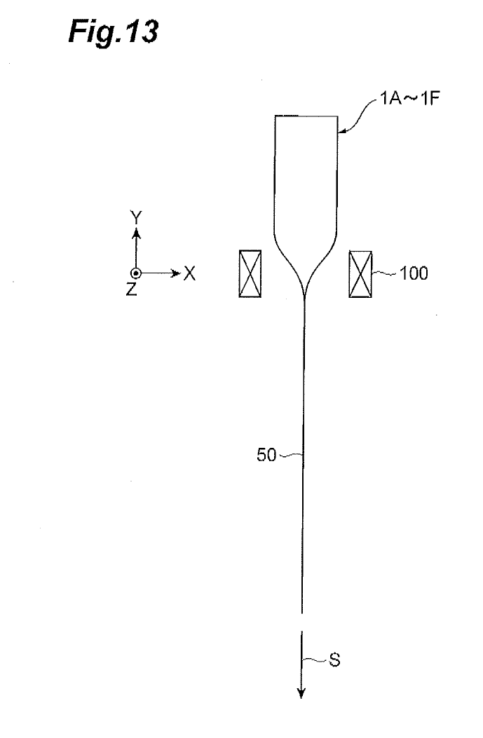

Subsequently, as shown in FIG. 3, the core members 10, the core array holding members 20 and the peripheral holding members 30 are inserted into a through-hole of a pipe 40 (constituting a part of the cladding) composed of silica glass, and the whole is made to be heated. Because of this, the core members 10, the core array holding members 20, the array holding members 30 and the pipe 40 are integrated into one piece, and a preform 1A for the multi-core optical fiber is obtained. The obtained preform 1A is drawn on appropriate wire drawing conditions by a wire drawing apparatus shown in FIG. 13. Thereby, a multi-core optical fiber 50 is produced. Note that, in the wire drawing apparatus of FIG. 13, one end of the produced preform 1A is made to be softened by being heated with a heater 100. This softened part is drawn out in the direction shown by arrow S in the figure, and thus the multi-core optical fiber 50 is obtained. A cross-section structure of the obtained multi-core optical fiber 50 has a similar figure to the cross-section structure of the preform 1A shown in FIG. 3.

As for the multi-core optical fiber 50 obtained by the above-mentioned production method, for example, a relative refractive index difference between a core and a cladding is 0.35%, a core diameter is 8 μm, and a distance between the centers of adjacent cores is 35 μm.

### Second Embodiment

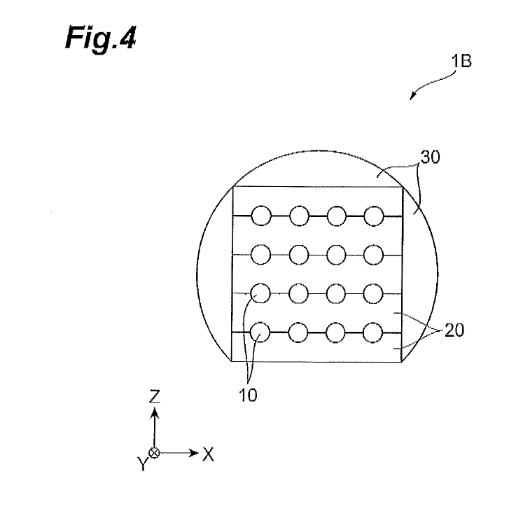

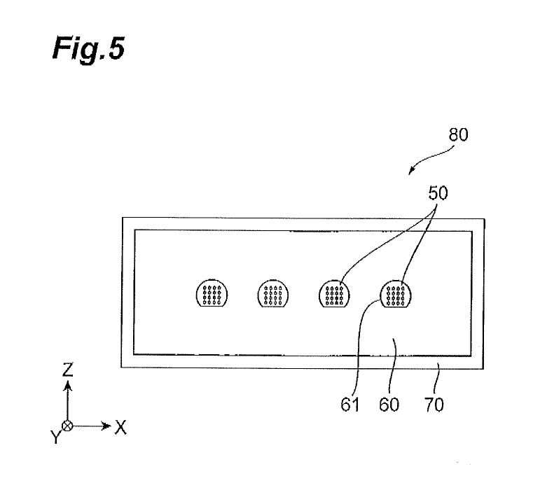

Then, a production method of a multi-core optical fiber and a multi-core optical fiber connector according to a second embodiment of the present invention will be described using FIGS. 4 and 5. The multi-core optical fiber according to the second embodiment utilizes the structure constituted by the core members, the core array holding members and the peripheral holding members in the same way as the multi-core optical fiber of the first embodiment. However, this second embodiment is an embodiment in which the shape of the preform for the multi-core optical fiber has anisotropy by changing an arrangement of the peripheral holding members, and the multi-core optical fibers are arranged in predetermined positions in the multi-core optical fiber connector, by utilization of this anisotropy.

First, in the same way as the first embodiment, the configuration shown in FIG. 1 is formed by using the core members 10 and the core array holding members 20. After that, the peripheral holding members 30 are arranged as shown in FIG. 4. A different point from the first embodiment shown in FIG. 2 is that the number of the peripheral holding members 30 arranged on the outside of the core array holding members 20 is reduced by one, and thus anisotropy has been made in a peripheral shape formed by the core array holding members 20 and the peripheral holding members 30. Then, the core members 10, the core array holding members 20, and the peripheral holding members 30 are integrated into one piece by heating the obtained anisotropic structure, and thereby, a preform 1B for the multi-core optical fiber is obtained. The obtained preform 1B is drawn on appropriate wire drawing conditions by the wire drawing apparatus shown in FIG. 13. Because of this, the multi-core optical fiber 50 having a cross-section structure which has a similar figure to a cross-section structure of the preform 1B is produced.

At this time, the multi-core optical fiber 50 after the drawing has an anisotropy in the cross-sectional shape based on the preform shape, and specifically, one end in which the peripheral holding member 30 has not been provided is substantially flattened. In addition, since the plane which is substantially flattened is the plane which has been formed by the core array holding member 20, the plane which is flattened will be in parallel with the plane where the cores are arranged, Consequently, in the case of having prepared a ferrule 60 matched to the cross-section structure of the multi-core optical fiber 50, it becomes possible to produce a multi-core optical fiber connector in which the core arraying direction (here, referred to as a plane in which the core members held by one core array holding member 20 are arrayed) of the multi-core optical fiber 50 and the direction of the ferrule are matched to each other. As an example, there is shown in FIG. 5 a multi-core optical fiber connector 80 in which each of four multi-core optical fibers 50 is inserted into a through-hole 61 of the ferrule 60 with the core arraying direction aligned, and furthermore, this is attached to a housing 70. In this multi-core optical fiber connector 80, four multi-core optical fibers 50 are attached by a connector joint. As a result, in the multi-core optical fiber connector 80 of FIG. 5, it becomes possible to collectively connect a total of 64 cores included in the four multi-core optical fibers.

### Third Embodiment

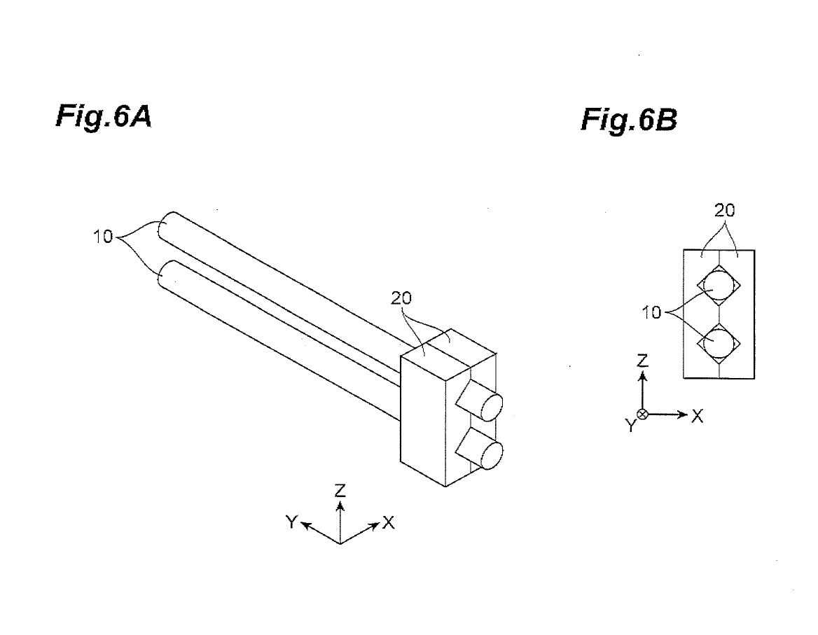

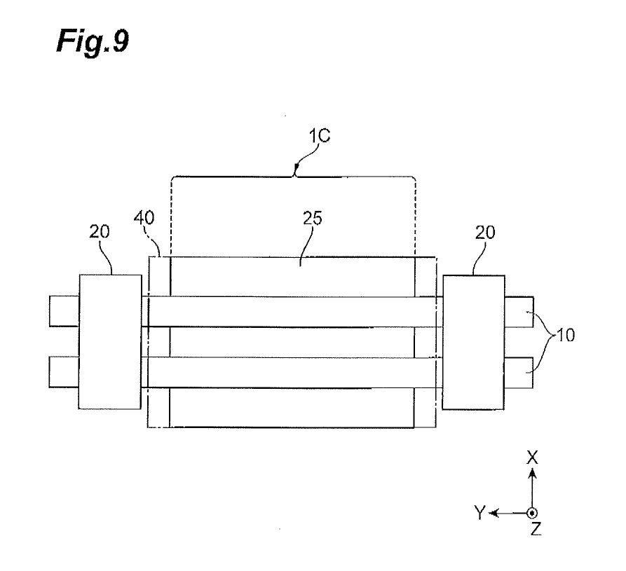

Then, a production method of a multi-core optical fiber according to a third embodiment of the present invention will be described using FIGS. 6A, 613, and 7 to 9. The multi-core optical fiber according to the third embodiment differs from the multi-core optical fiber of the first embodiment in the following respect. That is, the difference is that the core array holding member is not a member functioning as a cladding member. Therefore, the core array holding member, by holding the core member at one end side of the core member, for example, maintains the array (relative positional relation between cores) of the core members.

First, as shown in FIGS. 6A and 6B, two core members 10 composed of pure-silica glass are prepared, and one edge part of these is fixed by two core array holding members 20. FIG. 6A is a perspective view for describing a state where the core members 10 are fixed by two core array holding members 20, and FIG. 68 is a view where the holding state of FIG. 6A is viewed from a longitudinal direction of the core members 10. In the core array holding member 20, concave portions in accordance with a size of the core member 10 is provided. A material of the core array holding member 20 used here is not limited in particular.

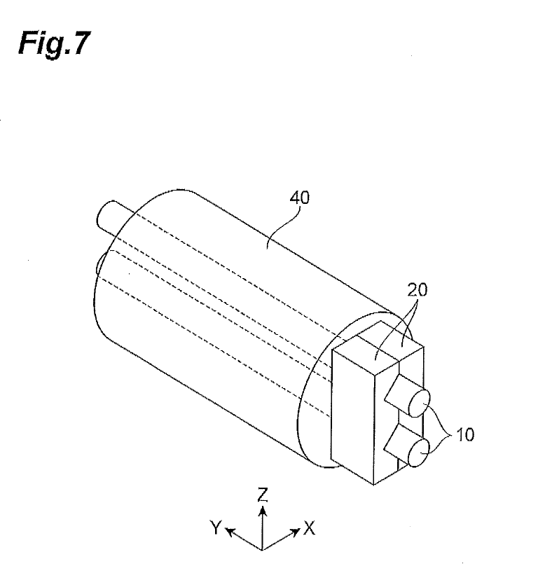

Then, as shown in FIG. 7, there is prepared the pipe 40 adjusted so that the difference in a relative refractive index with respect to the pure-silica glass may be −0.7% by adding fluorine to the silica glass. Into the prepared pipe 40, there are inserted two core members 10 from an edge part side opposite to the edge part with the core array holding members 20 fixed.

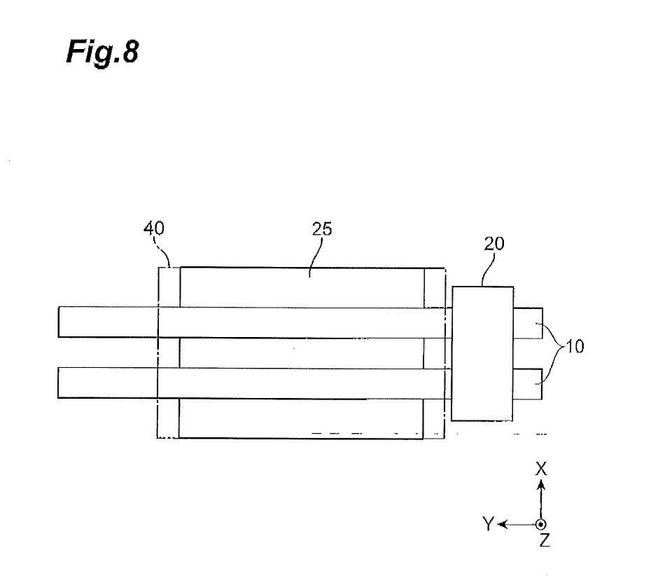

Next, as shown in FIG. 8, a cladding member 25 is inserted into a space in the pipe 40. As the cladding member 25, for example, there is used a material adjusted so that the difference in a relative refractive index with respect to the pure-silica glass may be set to be −0.7 by adding fluorine to the silica glass. Furthermore, as a configuration of the cladding member 25, there is considered a configuration such as a rod having a diameter smaller than that of the core member 10, or powder.

Then, also at the edge part opposite to the edge part with the core array holding members 20 fixed, the core members 10 are held by the core array holding members 20. Because of this, the position of the core members 10 is fixed by the core array holding members 20 at the both ends of the core members 10. In this state, by heating the position covered with the pipe 40, the core members 10, the pipe 40 and the cladding member 25 are integrated into one piece. After that, the core array holding member 20 is separated from the part integrated into one piece, and thus a preform 1C for the multi-core optical fiber is obtained. The obtained preform 1C is drawn on appropriate wire drawing conditions by the wire drawing apparatus of FIG. 13. Because of this, there is produced the multi-core optical fiber 50 with a cross-section which has a similar figure to the cross-sectional shape of the preform 1C. Note that, although not described in the figures, in a process of the integration into one piece, holding may be carried out with a jig or the like so that the relative positional relation between the core member holding members 20 at both ends and the pipe 40 is kept stable.

The pipe 40 and the cladding member 25 are the silica glass to which fluorine is added, and in the case of heating and integrating into one piece, a viscosity becomes lower than that of the core member of the pure-silica glass. In addition, the core members 10 are fixed by the core array holding members at both ends. Consequently, by heating these, a space of the cladding member 25 is filled up, and when the core members 10 and the cladding member 25 are integrated into one piece, the array and shape of the cores are kept stable. As a result, the multi-core optical fiber 50 in which the cores have been arrayed with high accuracy can be obtained.

Meanwhile, as for the multi-core optical fiber 50 obtained by the above-mentioned production method, for example, a relative refractive index difference between a core and a cladding is 0.7%, a core diameter is 5 μm, and an interval between the core centers is 25 μm. Note that, in the third embodiment, the multi-core optical fiber constituted by two core members has been described, and the number of the core members can be changed appropriately.

### Fourth Embodiment

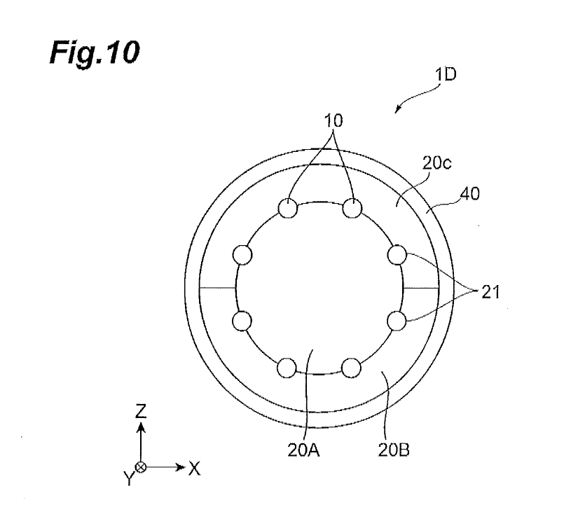

Then, a production method of a multi-core optical fiber according to a fourth embodiment will be described using FIGS. 10 to 12.

A method of holding the core members by the core array holding member is not limited to the method of arraying the core members on one plane as described in the above-mentioned first embodiment, and may be the method of arraying it in a circular shape, for example. In the fourth embodiment, a case where the core members are arranged on a circumference will be described.

First, there are prepared eight core members 10 which are composed of the pure-silica glass, an inner side core array holding member 20A, and outer side core array holding members 20B and 20C. Each of the inner side core array holding member 20A, and the outer side core array holding members 20B and 20C has a concave portion 21A having a peripheral shape substantially the same as the peripheral shape of the core member 10, and is obtained by uniformly adding fluorine to the silica glass so that the difference in a relative refractive index with respect to the pure silica glass may be −0.35%. The inner side core array holding member 20A has substantially a cylindrical external shape and has the concave portions 21 provided in the periphery thereof. In addition, each of outer side core array holding members 20B and 20C has substantially an arc-like external shape, and has the concave portions 21 provided in the inner side (short circumference side).

As a specific assembling method, as described in FIG. 10, after four core members 10 have been arranged in the concave portions 21 provided in the outer side core array holding member 20B on the lower side, the inner side core array holding member 20A is arranged thereon. At this time, the inner side core array holding member 20A is arranged so that the concave portions 21 of the inner side core array holding member 20A cover four core members. After that, after four core members 10 have been arranged on the upper part of the inner side core array holding member 20A, the upper outer side core array holding member 20C is arranged. Thereby, eight core members 10 are arranged, and a structure having a cross-section of substantially circular shape can be obtained.

After that, the core members 10 and the core array holding members 20A to 20C are inserted into the pipe 40 composed of the silica glass, and by heating the whole, the core members 10, the core array holding members 20A to 20C, and the pipe 40 are integrated into one piece. As a result, a preform 1D is obtained. The obtained preform 1D is drawn on appropriate wire drawing conditions by the wire drawing apparatus of FIG. 13, and there is produced the multi-core optical fiber 50 with a cross-section which becomes a similar figure to the cross-sectional shape of the preform 1D.

Note that, the multi-core optical fiber 50 obtained by the above-mentioned production method, for example, a relative refractive index difference between a core and a cladding is 0.35%, a core diameter is 8 an interval between the core centers is 40 μm, and a diameter of the cladding is 150 μm.

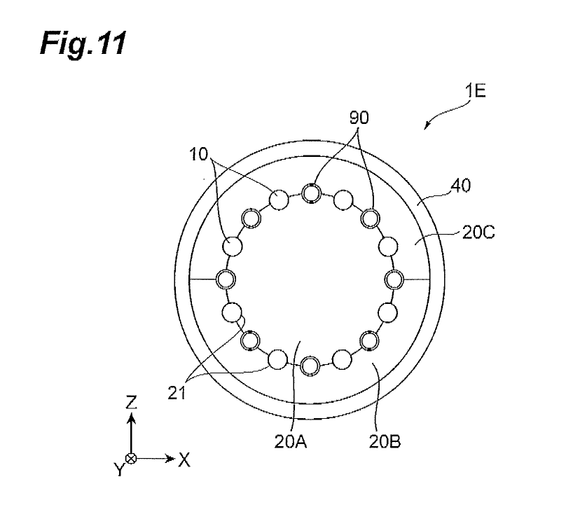

Furthermore, eight core members are used in the multi-core optical fiber 50 shown in FIG. 10, but hollow pipes can also be arranged each between adjacent core members. An example of this configuration is shown in FIG. 11. As shown in FIG. 11, the number of the concave portions in the core array holding members 20 is increased, and thus hollow pipes 90 are made to be able to be arranged each at the midpoint between eight core members 10, and the core members 10, the core array holding members 20A to 20C, the hollow pipes 90, and the pipe 40 are integrated into one piece, and a preform 1E for the multi-core optical fiber is obtained. Moreover, if the hollow pipe 90 is pressurized when the preform 1E is drawn by the wire drawing apparatus of FIG. 13, it becomes possible to maintain a hole part of the hollow pipe 90 after it has been made into a fiber. As for the multi-core optical fiber 50 obtained by being produced in this way, since a hollow part in which a refractive index is greatly decreased exists between adjacent cores, an effect of reducing a crosstalk between cores is exerted.

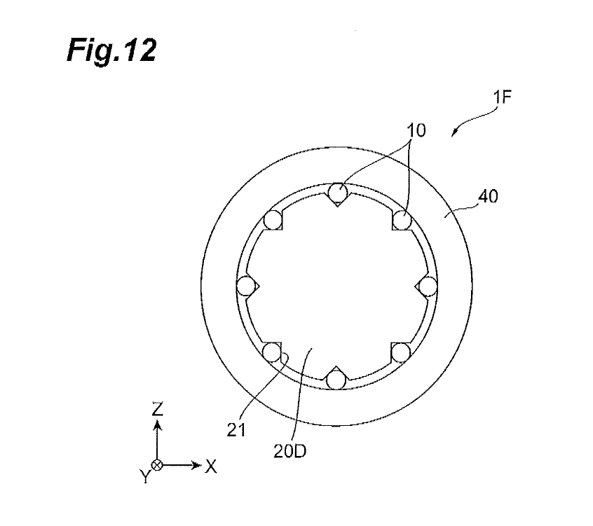

In addition, as shown in FIG. 12, by using only a core array holding member 20D which has the concave portions 21 and has substantially a cylindrical shape, composed of a material of the cladding member, by inserting this into the pipe 40 and by integrating it into one piece, it is also possible to acquire a preform 1F for the multi-core optical fiber. According to the method shown in FIG. 12, by using the core member holding member in which the number of parts is small and the production thereof is easy, it becomes possible to produce the multi-core optical fiber 50 shown in FIG. 10 (a stern apparatus of FIG. 13 is used). In this way, the shape of the core array holding member can be changed appropriately.

In accordance with the present invention, even in the case of increasing the size, there are provided the production method of the multi-core optical fiber and the production method of the multi-core optical fiber connector, which are capable of arranging the core members with high accuracy.

What is claimed is:

1. A production method of a multi-core optical fiber, comprising the steps of
supporting a plurality of core members each having a rod shape by an array fixing member, while fixing a relative positional relation of the plurality of core members;
producing a multi-core optical fiber preform by integrating at least the plurality of core members and a cladding member into one piece, after arranging the cladding member on the periphery of the plurality of core members whose the relative positional relation has been fixed by the array fixing member; and
producing the multi-core optical fiber by drawing the multi-core optical fiber preform.

2. The production method of the multi-core optical fiber according to claim 1, wherein the array fixing member is composed of the same material as the cladding member, and is integrated into each of the plurality of core members as a part of the cladding member.

3. The production method of the multi-core optical fiber according to claim 1, further comprising the step of separating the array fixing member from an integrated part, the integrated part being obtained by directly integrating the plurality of core members and the cladding member into one piece while a part of each of the plurality of core members is supported by the array fixing member.

4. The production method of the multi-core optical fiber according to claim 1, wherein the array fixing member has a plurality of concave portions each substantially corresponding to an outer peripheral shape of, each of the plurality of core members, and
wherein the relative positional relation of the plurality of core members is fixed by disposing each of the plurality of core members on the associated one of the plurality of concave portions of the array fixing member.

5. The production method of the multi-core optical fiber according to claim 1, wherein the multi-core optical fiber preform has anisotropy on a cross section thereof which is perpendicular to a longitudinal direction of each of the plurality of core members.

6. The production method of the multi-core optical fiber according to claim 5, wherein the multi-core optical fiber preform has a flat edge on the cross section thereof.

7. The production method of the multi-core optical fiber according to claim 1, wherein the cladding member is constituted by a plurality of members.

8. A production method of a multi-core optical fiber connector, comprising the steps of preparing a multi-core optical fiber produced by the production method of the multi-core optical fiber according to claim 5, the multi-core optical fiber having anisotropy on the cross section thereof which is perpendicular to the longitudinal direction of each of the plurality of core members; and
producing the multi-core optical fiber connector by inserting the prepared multi-core optical fiber into a hole provided on a ferrule, the hole having anisotropy corresponding to an outer peripheral shape of the multi-core optical fiber.

9. The production method of the multi-core optical fiber according to claim 1, wherein the array fixing member includes a plurality of array holding members which hold the plurality of core members in cooperation from a direction perpendicular to a longitudinal direction of each of the plurality of core members.

10. The production method of the multi-core optical fiber according to claim 9, wherein each of, the plurality of array holding members is composed of the same material as the cladding member, and is integrated into each of the plurality of core members as a part of the cladding member.

11. The production method of the multi-core optical fiber according to claim 9, further comprising the step of separating the plurality of array holding members from an integrated part, the integrated part being obtained by directly integrating the plurality of core members and the cladding member into one piece while a part of each of the plurality of core members is held by the plurality of array holding members.

12. The production method of the multi-core optical fiber according to claim 9, wherein at least one of the plurality of array holding members has a plurality of concave portions each substantially corresponding to an outer peripheral shape of each of the plurality of core members, and
wherein the relative positional relation of the plurality of core members is fixed by disposing each of the plurality of core members on the associated one of the plurality of concave portions provided in at least one of the plurality of array holding members.

13. The production method of the multi-core optical fiber according to claim 9, wherein the multi-core optical fiber preform has anisotropy on a cross section thereof which is perpendicular to a longitudinal direction of each of the plurality of core members.

14. The production method of the multi-core optical fiber according to claim 13, wherein the multi-core optical fiber preform has a flat edge on the cross section thereof.

15. The production method of the multi-core optical fiber according to claim 9, wherein the cladding member is constituted by a plurality of members.

16. A production method of a multi-core optical fiber connector, comprising the steps of preparing a multi-core optical fiber produced by the production method of the multi-core optical fiber according to claim 13, the multi-core optical fiber having anisotropy on the cross section thereof which is perpendicular to the longitudinal direction of each of the plurality of core members; and
producing the multi-core optical fiber connector by inserting the prepared multi-core optical fiber into a hole provided on a ferrule, the hole having anisotropy corresponding to an outer peripheral shape of the multi-core optical fiber.
